(19) United States
(12) Patent Application Publication
(10) Pub. No.: US 2014/0078537 A1
(43) Pub. Date: Mar. 20, 2014

(54) IMAGE FORMING APPARATUS, CONTROL PROGRAM OF IMAGE FORMING APPARATUS AND METHOD FOR CONTROLLING IMAGE FORMING APPARATUS

(71) Applicant: Konica Minolta, Inc., Chiyoda-ku (JP)

(72) Inventor: Toshihisa MOTOSUGI, Okazaki-shi (JP)

(73) Assignee: Konica Minolta, Inc., Chiyada-ku (JP)

(21) Appl. No.: 14/024,816

(22) Filed: Sep. 12, 2013

(30) Foreign Application Priority Data
Sep. 14, 2012 (JP) 2012-203628

(51) Int. Cl. H04N 1/23

(52) U.S. Cl. CPC H04N 1/2338
USPC 358/1.13

(57) ABSTRACT

An MFP (1) receives a mode change instruction for changing an operational mode after reading of an document starts (S102 to S105), and determines whether or not re-reading of the document is necessary in order to complete the job depending on the mode change instruction (S106). If it is determined that re-reading is necessary, the re-reading of the document starts (S116). If it is determined that the re-reading is not necessary, the reading of the document is continuously performed.

### CROSS-REFERENCE TO RELATED APPLICATION

This application is based on Japanese Patent Application No. 2012-203628 filed on Sep. 14, 2012, the contents of which are incorporated herein by reference.

### BACKGROUND

1. Technical Field

The present invention relates to an image forming apparatus executing a job involved in reading of a document, a control program of the image forming apparatus and a method for controlling the image forming apparatus. And more particularly, the present invention relates to an image forming apparatus, a control program of the image forming apparatus and a method for controlling the image forming apparatus which are capable of receiving an instruction for changing an operational mode for the job after the reading of a document starts.

2. Description of Related Art

Typically, in a case where a document is read for a copy operation using an image forming apparatus such as a multi-function peripheral (MFP), it is difficult to start reading of the document until a copy setting is selected in detail on an operation panel. Once reading of the document starts, a user is not allowed to change the copy setting until the reading is terminated.

However, if the MFP is controlled to change the copy setting during the reading of a document, a user is allowed to effectively use time after the reading starts. Therefore, such as a control is very convenient in a case where the number of document is significant, or a complicated copy setting is performed. It is conceived that such a control method will be also effective in a case where a user recognizes that the copy setting is erroneously performed after the reading starts.

In this regard, Japanese Patent Unexamined Publication No. 2001-103202 proposes an image forming apparatus capable of receiving an instruction of changing an operational mode during the reading of a document. This image forming apparatus interrupts reading of a current reading page at the time of the change instruction. Then, as a start button is pressed, the reading is resumed depending on an operational mode after the change.

However, in such an image forming apparatus, the reading is interrupted without exception when the operation mode change instruction is received. Therefore, a user's effort or the time elapsing for the job does not change, compared to a case where the job is cancelled, and the operational mode is then selected again. For this reason, in a case where the operational mode changes after reading of a document starts, the time elapsing until the job is completed may significantly increase.

In addition, Japanese Patent Unexamined Publication No. 2009-88597 proposes an image forming apparatus using a dual scan (DS) functionality of an automatic document feeder (ADF), in which a mode switching during the reading can be made between a mode (1-pass mode) for simultaneously reading double sides through a single sheet-passing operation and a mode (circulation mode) for reading each side through a single sheet-passing operation. Furthermore, Japanese Patent Unexamined Publication No. 2002-27169 discloses an image forming apparatus capable of reading the next document and displaying setting information only for the reading of the next document even while the preceding document is printed.

### SUMMARY

To achieve at least one of the abovementioned objects, there is provided an image forming apparatus reflecting one aspect of the present invention executes a job involved in reading of a document and comprises a reading part, a receiving part, a determination part and a control part. The reading part starts reading of the document depending on an operational mode specified in advance. The receiving part receives an operational mode change instruction after the reading of the document starts. The determination part determines whether or not re-reading of the document is necessary in order to complete the job depending on an operational mode changed by the change instruction. The control part controls an operation of the reading part such that re-reading of the document starts if it is determined that re-reading of the document is necessary, or the document is continuously read if it is determined that the re-reading is not necessary.

With respect to the above image forming apparatus, it is preferable that the control part controls an operation of the reading part such that the reading of the document is interrupted if the change instruction is received before the reading of the document is terminated.

With respect to the above image forming apparatus, it is preferable that the control part controls an operation of the reading part such that the reading of the document is interrupted after a currently reading page at the time of receiving the change instruction is completely read.

With respect to the above image forming apparatus, it is preferable that an output of the job is interrupted if the change instruction is received after the reading of the document is terminated.

With respect to the above image forming apparatus, it is preferable that the determination part determines that re-reading of the document is necessary if the output image quality of the job is changed by the change instruction.

With respect to the above image forming apparatus, it is preferable that the determination part determines that re-reading of the document is necessary if a reading range or a reading speed of the document is changed by the change instruction.

The above image forming apparatus preferably further comprises a display unit that displays a message for urging a user to perform a re-reading preparation job of the document if it is determined that re-reading of the document is necessary.

With respect to the above image forming apparatus, it is preferable that the receiving part further receives a confirmation instruction regarding whether or not the change instruction is confirmed if it is determined that re-reading of the document is necessary, and the change instruction is cancelled except for a case where the confirmation instruction for confirming the change instruction is received.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a schematic diagram illustrating an exterior of an image forming apparatus according to an embodiment of the present invention;

FIG. 2 is a block diagram illustrating a configuration of the image forming apparatus according to an embodiment of the present invention;

FIG. 3 is a schematic diagram illustrating an exemplary operation screen (for mode selection) according to an embodiment of the present invention;

FIG. 4 is a schematic diagram illustrating an exemplary operation screen (for mode selection) according to an embodiment of the present invention;

FIG. 5 is a schematic diagram illustrating an exemplary operation screen (for mode selection) according to an embodiment of the present invention;

FIG. 6 is a schematic diagram illustrating an exemplary operation screen (for mode selection) according to an embodiment of the present invention;

FIG. 7 is a flowchart illustrating a sequence of a mode change processing according to an embodiment of the present invention;

FIG. 8 is a flowchart illustrating a sequence of a mode change processing according to an embodiment of the present invention (following from FIG. 7);

FIG. 9 is a flowchart illustrating a sequence of a mode change processing according to an embodiment of the present invention (following from FIGS. 7 and 8);

FIG. 10 is a schematic diagram illustrating an exemplary operation screen (for mode change) according to an embodiment of the present invention (for mode change); and

FIG. 11 is a schematic diagram illustrating an exemplary operation screen (for mode change confirmation) according to an embodiment of the present invention.

### DETAILED DESCRIPTION

Hereinafter, an embodiment of the present invention will be described in detail with reference to the accompanying drawings.

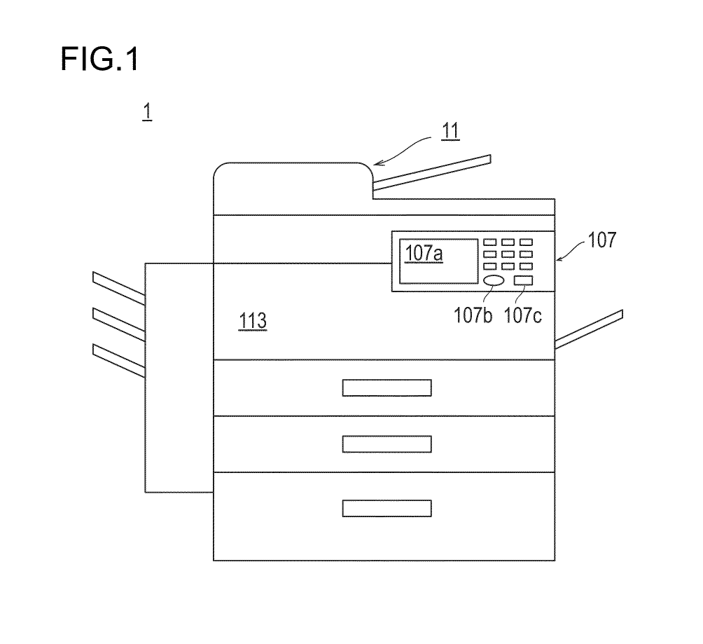

FIG. 1 is a schematic diagram illustrating an exterior of an image forming apparatus (multi-function peripheral (MFP) 1) according to the present embodiment. As illustrated in FIG. 1, the MFP 1 includes an automatic document feeder (ADF) 11, an operation panel 107, a print engine 113, and the like.

In addition, the MFP 1 has a copy functionality of duplicating, on a sheet, image information created by reading a document set in the ADF 11, a scan functionality of digitalizing image information created by reading a document set in the ADF 11 and storing the image information, and a facsimile functionality of transmitting image information created by reading a document set in the ADF 11 via a public switched network.

In this manner, the MFP 1 can execute a job involved in reading of a document set in the ADF 11 and the like. In the present embodiment, a “job” refers to a series of operations executed in response to various user's instructions received using an operation panel 107, a network interface card (NIC) 108, and the like.

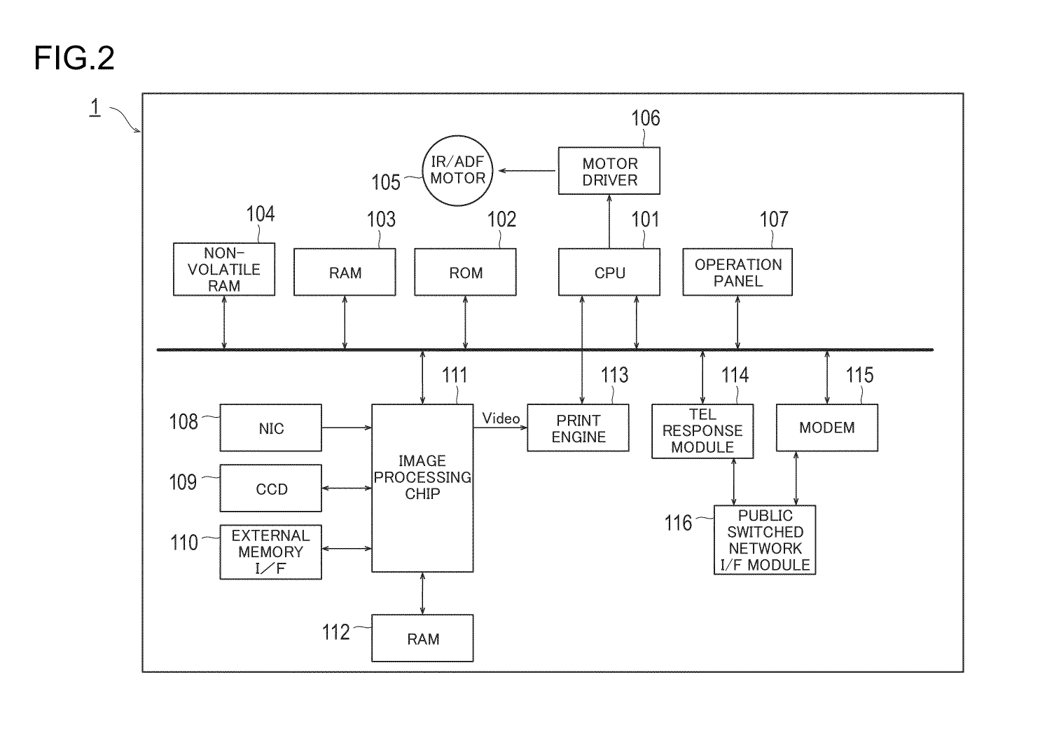

FIG. 2 is a block diagram illustrating a configuration of the MFP 1. As illustrated in FIG. 2, the MFP 1 includes a central processing unit (CPU) 101, a read-only memory (ROM) 102, a random access memory (RAM) 103, a non-volatile RAM (104), an image reader/auto document feeder (IR/ADF) motor 105, a motor driver 106, and an operation panel 107.

The CPU 101 controls the operation of each unit based on a control program and executes various computation processings. The ROM 102 stores control programs, parameters, and the like for controlling a basic operation of the MFP 1. The RAM 103 temporarily stores a control program and the like and serves as a job area of the CPU 101. The non-volatile RAM 104 stores an operating system (OS), a control program, and the like.

The IR/ADF motor 105 is a driving apparatus for delivering the document set in the ADF 11 to a document tray. The motor driver 106 is a control device for controlling the operations of the IR/ADF motor 105.

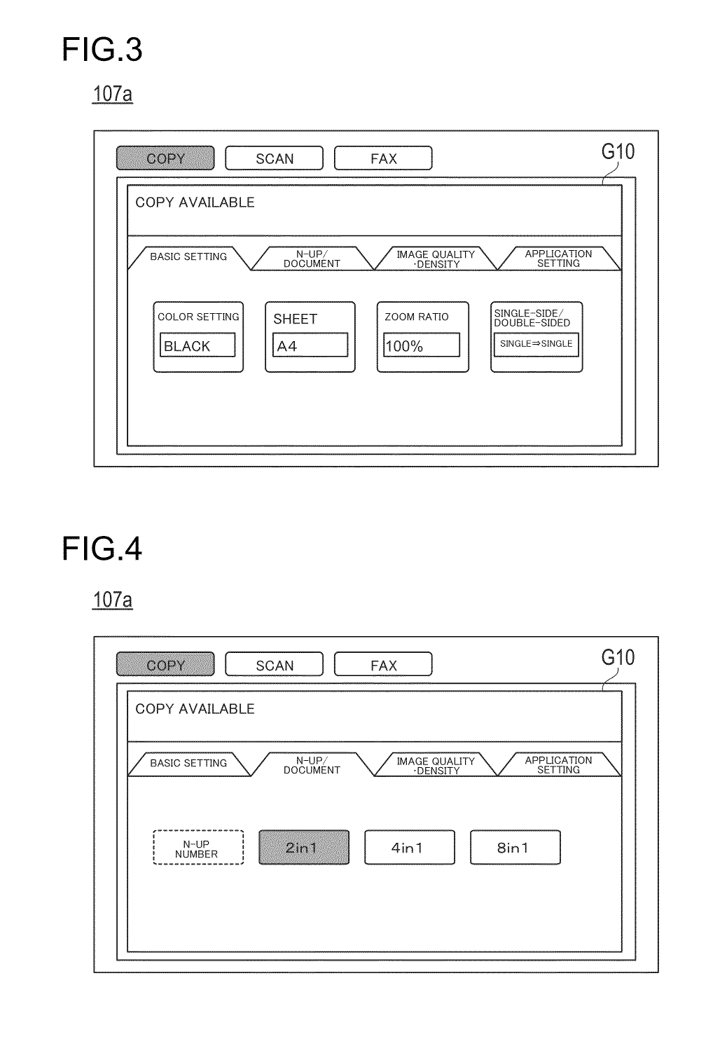

The operation panel 107 has a display unit 107a such as a liquid crystal display (LCD) and an organic electroluminescence (EL) display and an input unit including a combination of a touch panel, a keypad, and the like. Here, the display unit 107a displays an operation screen (refer to FIGS. 3 to 6) for causing a user to select detailed settings of each functionality (such as copy, scan, and facsimile). According to the present embodiment, the detailed setting of each functionality of the MFP 1 is referred to as an “operational mode,” and the operation screen for causing a user to select an operation mode is referred to as an operation screen for mode selection.

The input unit includes a start button 107b that receives an instruction for starting a job depending on the selected operational mode on the operation screen for mode selection, a mode change button 107c that receives an instruction for changing the operational mode after starting reading of the document, and the like. The mode change button 107c will be described below in more detail.

As illustrated in FIG. 2, the MFP 1 includes a network interface card (NIC) 108, a charge-coupled device (CCD) 109, an external memory I/F 110, an image processing chip 111, a RAM 112, a print engine 113, a telephone (TEL) response module 114, a modem 115, and a public switched network I/F module 116.

The NIC 108 is an interface for communication with an external device via a local area network (LAN). The CCD 109 is an image sensor for converting reflection light obtained by irradiating light onto the document delivered to the document tray into an electric signal and is arranged under the document tray. The external memory I/F 110 is an interface for communication with a removable memory device such as a universal serial bus (USB) memory or a secure digital (SD) card.

The image processing chip 111 executes a raster image processing (RIP) for page description language (PDL) format print data. In addition, the image processing chip 111 executes various image quality processings for the image data created through the RIP. The RAM 112 temporarily stores various data and serves as a job area of the image processing chip 111. The print engine 113 prints, on a sheet, an image based on the image data in the RAM 112 using an electrographic print process. Alternatively, the print engine 113 may employ other print techniques such as an impact type or an ink-jet type.

The TEL response module 114 transmits and/or receives various signals to/from the counterpart device to determine a communication rate, an encoding type, and the like when a facsimile is received. The modem 115 modulates a digital signal of the image information into an analog signal when a facsimile is transmitted. The modem 115 demodulates an analog signal of the image information into a digital signal when a facsimile is received. The public switched network I/F module 116 is an interface for communication with a counterpart device via a public switched network when a facsimile is transmitted and/or received.

Next, an operation screen displayed on the display unit 107a of the operation panel 107 will be described. FIGS. 3 to 6 are schematic diagrams illustrating an operation screen G10 for mode selection corresponding to the “copy” functionality of the MFP 1. As illustrated in FIGS. 3 to 6, the operation screen G10 includes tabs for each setting item, including a “Basic Setting” tab, an “N-UP/Document” tab, an “Image Quality·Density” tab, an “Application Setting” tab, and the like. A user can switch from a currently displayed tab to a tab of another setting item by touching any one of the tabs.

The operation panel 107 has functionality selection buttons corresponding to each functionality of the MFP 1 (such as “Copy,” “Scan,” and “FAX”). A user can switch a currently displayed operation screen to an operation screen having another functionality by touching any one the functional selection buttons.

FIG. 3 illustrates an exemplary “Basic Setting” tab of the operation screen G10 having a copy functionality. As illustrated in FIG. 3, a user may select “Color Setting,” “Sheet,” “Zoom Ratio,” “Single-sided/Double-sided,” or the like on the “Basic Setting” tab when a copy operation is executed. Here, a user may select, for example, “Black (Monochromatic),” “Full Color,” or the like as the “Color Setting.” A user may select, for example, “A4” “B4” “A3” “Automatic” or the like as the “Sheet.” In addition, a user may select a desired zoom-out or zoom-in ratio as the “Zoom Ratio.” A user may select, for example, “Single→Single,” “Single→Double,” “Double→Single,” “Double→Double,” and the like as the “Single-sided/Double-sided.”

FIG. 4 illustrates an exemplary “N-UP/Document” tab of the operation screen G10 of a copy functionality. As illustrated in FIG. 4, a user may select organized printing (N-Up printing) using a layout such as “2 in 1,” “4 in 1,” and “8 in 1” on the “N-UP/Document” tab. In the drawing, N-UP printing based on a “2 in 1” layout is selected.

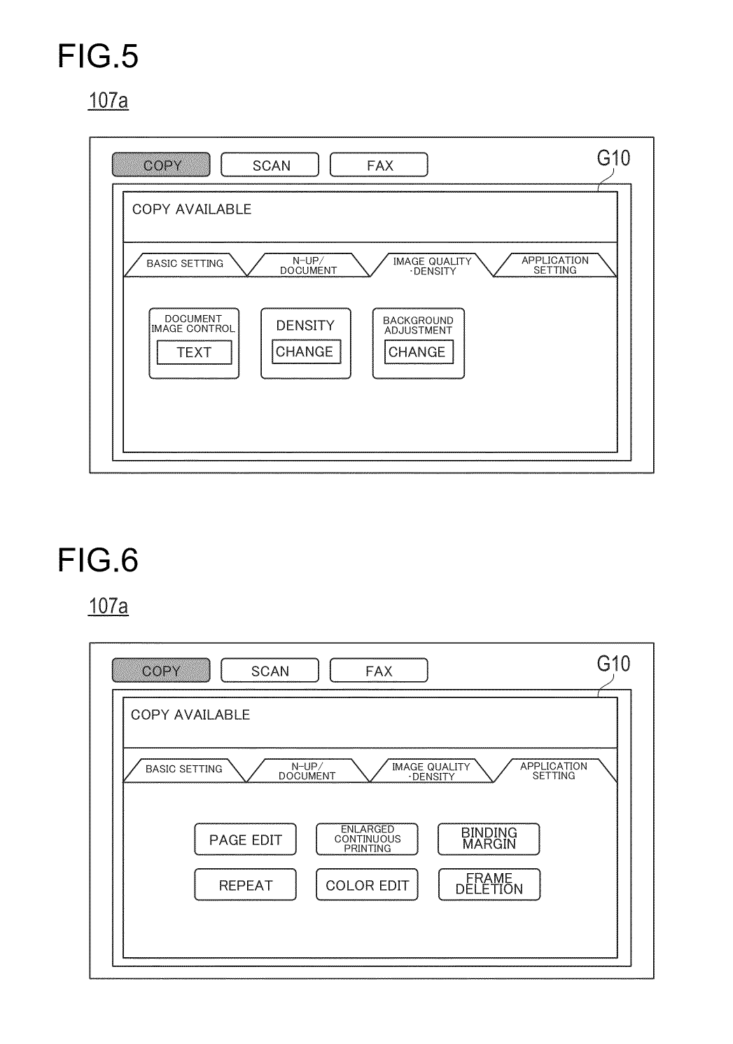

FIG. 5 illustrates an exemplary “Image Quality·Density” tab of the operation screen G10 of a copy function. As illustrated in FIG. 5, on the “Image Quality·Density” tab, a user may select “Document Image Quality,” “Density,” “Background Adjustment,” and the like when a copy operation is executed. Here, the “Document Image Quality” refers to an image quality processing suitable for the type of the document. A user may select, for example, “Text,” “Photograph,” “Text Photo Mix,” “Map,” “Thin Text,” or the like as the “Document Image Quality.” In addition, a user may adjust each print image and a background gray-scale by touching a “Change” button of the “Density” and the “Background Adjustment.”

FIG. 6 illustrates an exemplary “Application Setting” tab of an operation screen G10 of a copy functionality. As illustrated in FIG. 6, a user may select “Page Edit,” “Repeat,” “Enlarged Continuous Printing,” “Color Edit,” “Binding Margin,” “Frame Deletion,” and the like when a copy functionality is executed on the “Application Setting” tab.

Here, the “Page Edit” refers to a setting regarding insertion of a cover sheet or a special sheet into print-outs. In addition, “Repeat” refers to a setting for repeatedly printing a reduced document image on a single sheet. A user may select a reading range of the document image by touching the “Repeat” button.

The “Enlarged Continuous Printing” refers to a setting for dividing a single document image into a plurality of parts and enlargedly printing each part per single sheet. A user may select a finish size of the print-outs by touching the “Enlarged Continuous Printing” button.

The “Color Edit” refers to a setting regarding contrast, brightness, chroma, sharpness, hue, and the like. In addition, the “Binding Margin” refers to a setting regarding a binding direction (right-side binding/left-side binding) when the print-outs are bound. The “Frame Deletion” refers to a setting for removing an unnecessary border line from the document image read by the CCD 109.

The MFP 1 having such a configuration executes a copy job depending on an operational mode selected on the operation screen G10 when a user presses the start button 107b. As a result, the document set on the ADF 11 starts to be read.

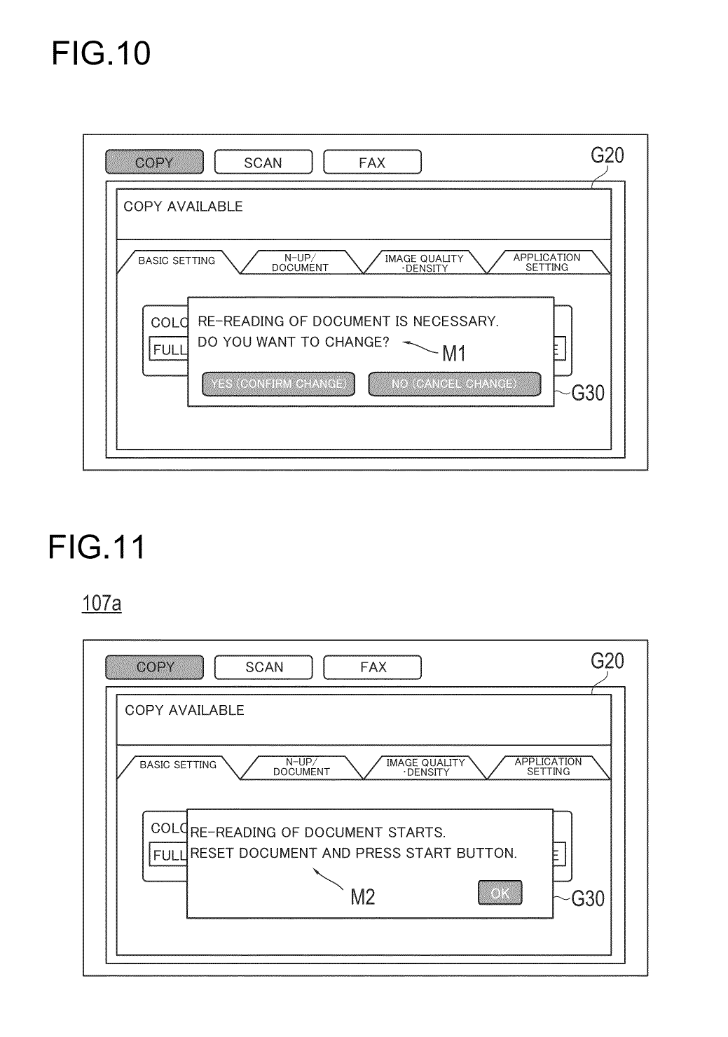

The MFP 1 according to the present embodiment can change the operational mode for the copy job even after the reading of a document starts. More specifically, the MFP 1 displays an operation screen G20 for mode change on the display unit 107a (refer to FIGS. 10 and 11) when the mode change button 107c is pressed after the reading of a document starts. Then, the MFP 1 receives an instruction, from a user, for changing the operational mode on the operation screen G20. Hereinafter, such an instruction will be referred to as a “mode change instruction.”

The operation screen G20 for mode change is similar to the operation screen G10 for mode selection described above. However, while a message “copy is available” is displayed on the operation screen G10 for mode selection (refer to FIGS. 3 to 6), a message “mode change is available” is displayed on the operational screen G20 (refer to FIGS. 10 and 11).

In some cases, when the operational mode changes, the MFP 1 resumes the reading of the document that has already started. In order to distinguish the first reading and the second or subsequent reading, the second or subsequent reading will be referred to as “re-reading.” The re-reading of a document will be described below in more detail.

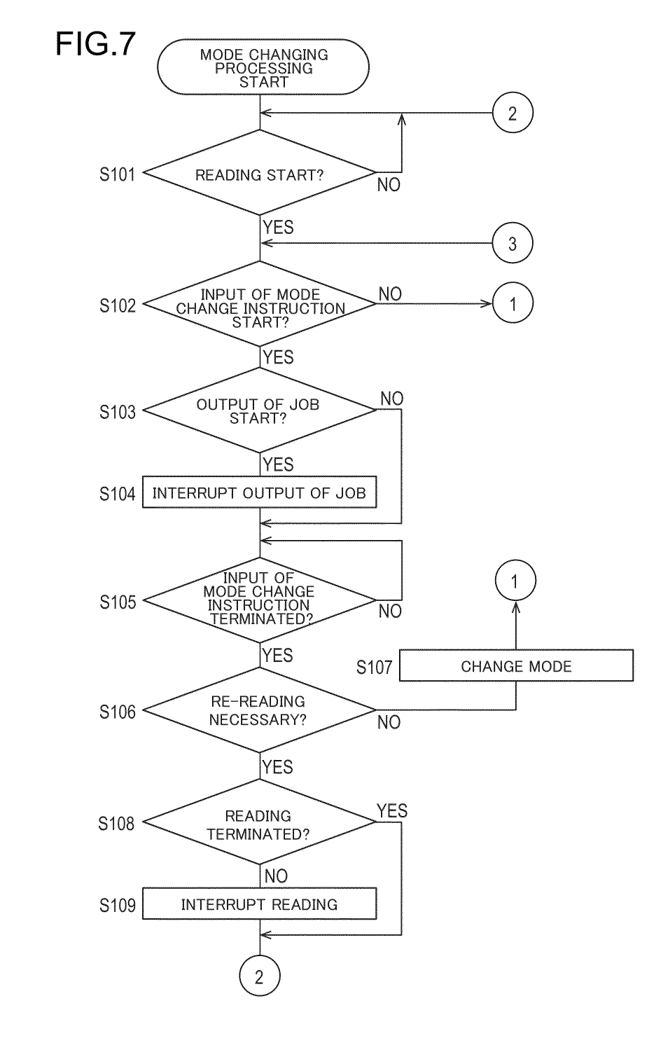

Next, an operation in the MFP 1 according to the present embodiment will be described in brief. FIGS. 7 to 9 are flowcharts illustrating a sequence of the processing performed by the MFP 1 to receive a mode change instruction after starting the reading of a document and start re-reading of the document depending on the changed mode. This processing will be referred to as a “mode change processing.” The algorithm illustrated in the flowcharts of FIGS. 7 to 9 is stored in the ROM 102 as a control program.

As illustrated in FIG. 7, first, the MFP 1 waits until the reading of a document starts (NO in step S101). In addition, as the reading starts (YES in step S101), it is determined whether or not the mode change instruction starts to be input from a user (step S102). Here, it is assumed that the input of the mode change instruction starts when a user presses the mode change button 107c of the operation panel 107.

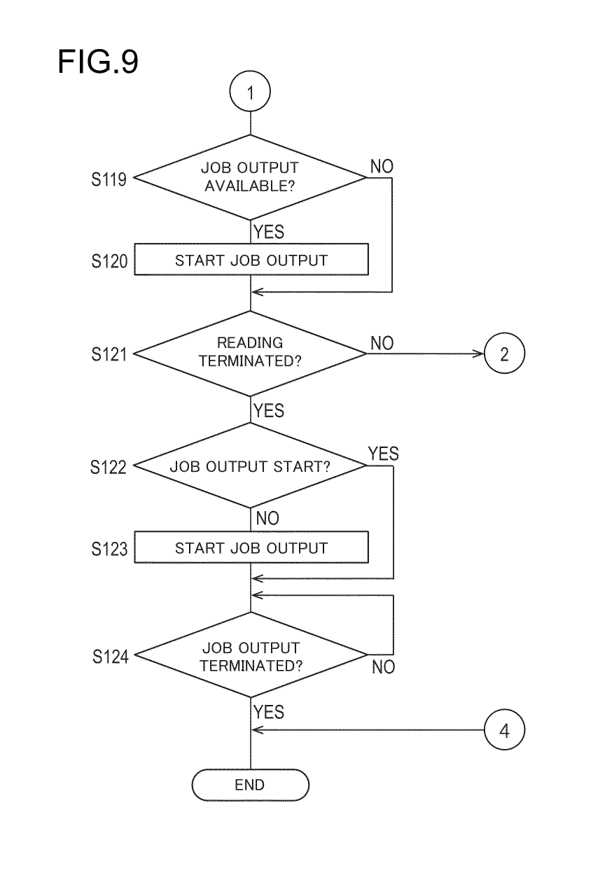

Subsequently, if the mode change instruction starts to be input from a user (YES in step S102), it is determined whether or not the current processing job starts to be output (step S103). If it is determined that the job has already started to be output (YES in step S103), the printing is interrupted (step S104), and the process advances to step S105. Otherwise, if it is determined that the job has not started to be output (NO in step S103), the process directly advances to step S105 described below. Meanwhile, if the mode change instruction has not started to be input from a user (NO in S102), the process advances to step S119 described below (refer to FIG. 9).

Subsequently, the MFP 1 waits until the input of the mode change instruction from a user is terminated (NO in step S105). Here, it is assumed that the input of the mode change instruction is terminated when the start button 107b is pressed after the mode change button 107c is pressed. In addition, as the input of the mode change instruction from a user is terminated (YES in step S105), it is determined whether or not re-reading of a document is necessary to complete the job depending on the changed mode.

More specifically, in step S106, it is determined whether or not the mode change instruction from a user influences an output result of the current processing job. For example, the MFP 1 determines that the re-reading of the document is necessary in a case where a setting of “Color” changes on the “Basic Setting” tab. This is because a control method of each part at the time of reading is different depending on the setting of “Color.”

In addition, the MFP 1 determines that re-reading of the document is necessary even when the setting of “Document Image Quality” or “Density” changes on the “Image Quality·Density” tab. This is because, it the setting of “Document Image Quality” or “Density” changes, an image quality processing corresponding to the changed mode is separately necessary. In this manner, according to the present embodiment, preferably, it is determined that re-reading of a document is necessary in a case where the output image quality of the job is changed by the mode change instruction.

Similarly, the MFP 1 determines that re-reading of a document is necessary in a case where the setting of “Zoom Ratio” changes on the “Basic Setting” tab. This is because a control method of each part at the time of reading is different depending on the “Zoom Ratio.”

In addition, the MFP 1 also determines that re-reading of a document is necessary in a case where the setting of “Repeat” or “Enlarged Continuous Printing” on the “Application Setting” tab changes. This is because a control method of each part at the time of reading is different depending on the setting of “Repeat” or “Enlarged Continuous Printing.” In particular, this is because a reading range of a document changes depending on a reading range of the “Repeat” or a finish size of the “Enlarged Continuous Printing.” In this manner, according to the present embodiment, preferably, it is determined that re-reading of a document is necessary in a case where a reading range or a reading speed of the document is changed by the mode change instruction.

If it is determined that re-reading of the document is necessary (YES in step S106), it is further determined whether or not reading of the document is terminated (step S108). Otherwise, if it is determined that re-reading of the document is not necessary (NO in step S106), the mode changes depending on the mode change instruction (step S107). Then, the process advances to step S119 described below.

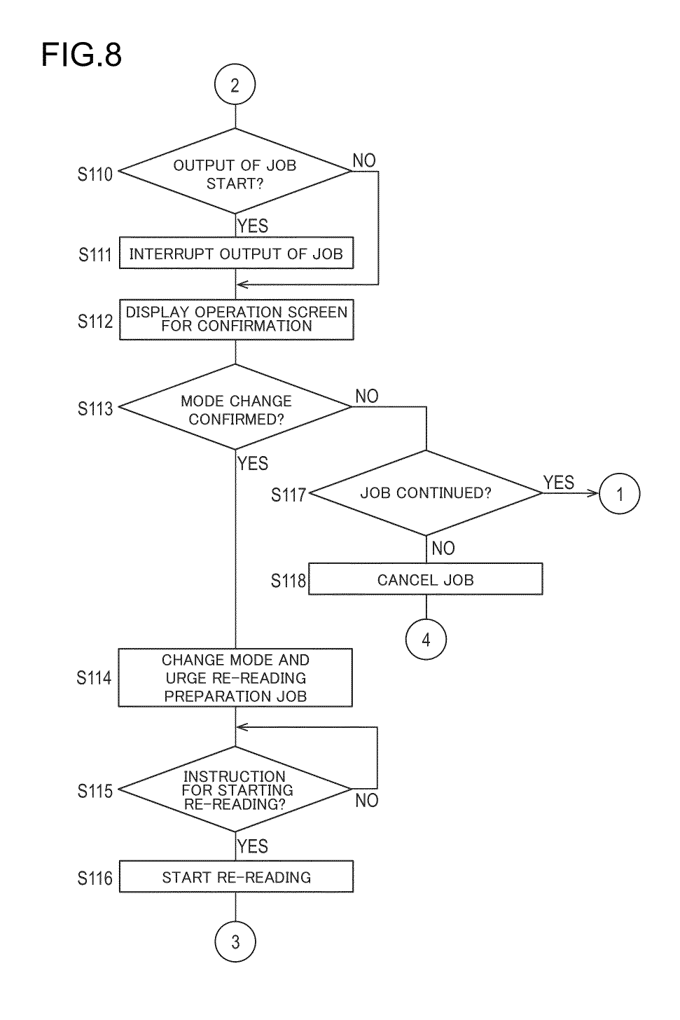

Subsequently, if it is determined that reading of the document is terminated in step S108 (YES in step S108), the process directly advances to step S110 described below. If it is determined that reading of the document is not terminated (NO in step S108), the reading of the document is interrupted (S109), and the process advances to step S110 described below (refer to FIG. 8). In step S109, preferably, the reading is interrupted after the current reading page is completely read when the mode change instruction starts to be input from a user

Referring to FIG. 8, in step S110, it is determined whether or not the current processing job starts to be output. If it is determined that the job starts to be output (YES in step S110), the printing is interrupted (S111), and the process advances to step S112 described below. Otherwise, if it is determined the current processing job does not start to be output (NO in step S110), the process directly advances to step S112 described below. The “Output of Job” in a case where a copy job is executed by the MFP 1 as in this example refers to a case where a document image is printed on a sheet using the print engine 113.

Subsequently, in step S112, an operation screen G30 for causing a user to select whether or not the mode change is confirmed is displayed on the operation panel 107. Such an operation screen will be referred to as an operation screen for mode change confirmation. FIG. 10 is a schematic diagram illustrating an exemplary operation screen G30 for mode change confirmation.

As illustrated in FIG. 10, the operation screen G30 for mode change confirmation preferably displays a message M1 for notifying a user of a fact that re-reading of a document is necessary to complete the job depending on the changed mode. In the example of FIG. 10, a message “Re-reading of document is necessary. Do you want to change?” is displayed as the message M1.

In addition, a user can confirm the mode change by pressing a “Yes (for confirming the mode change)” button on the operation screen G30 for mode change confirmation. Otherwise, a user can cancel the mode change by pressing a “No (for canceling the mode change)” button.

Subsequently, the MFP 1 determines whether or not the instruction for confirming the mode change is received on the operation screen G30 (step S113). If it is determined that the instruction for confirming the mode change is received (YES in step S113), the mode of the current processing job changes, and a message M2 for urging a user to perform a re-reading preparation job is displayed on the display unit 107a (step S114). Here, the “re-reading preparation job” refers to a job in which the document is set on the ADF 11 again, and the start button 107b is then pressed. FIG. 11 is a schematic diagram illustrating an exemplary message M2 according to the present embodiment.

On the other hand, if the instruction for canceling the mode change is received on the operation screen G30 (NO in step S113), an operation screen (not illustrated) for causing a user to select whether or not the current processing job is continuously performed is displayed, and it is determined whether or not the current processing job is continuously performed depending on a result of the user's selection on the operation screen (step S107). In addition, if it is determined that the job is continuously performed (YES in step S117), the process advances to step S119 described below (refer to FIG. 9). Otherwise, if it is determined that the job is not continuously performed (NO in step S117), the job is cancelled (S118), and the mode change processing is terminated (refer to FIG. 9).

Subsequently, the MFP 1 waits until a re-reading instruction is received from a user (that is, until the start button 107b is pressed again) (NO in step S115). In addition, as the re-reading instruction is received (YES in step S115), the re-reading of the document set on the ADF 11 starts (S116), and the process returns to step S102 described above.

Referring to FIG. 9, in step S119, it is determined whether or not the current processing job has a printable state. Such determination is made because, depending on the setting of the operational mode selected on the operation screen G10 or G20, the job may start to be output before the reading is terminated (that is, the reading and the output can be processed at the same time), or it may be difficult to start to output the job before the reading is terminated (that is, it is difficult to start the output until the reading is terminated).

If the job has a printable state (YES in step S119), the process advances to step S121 described below after the job starts to be output (step S120). If the job does not have a printable state (NO in step S119), the process directly advances to step S121 described below. Then, in step S121, it is determined whether or not the reading (or re-reading) of the document is terminated. If it is determined that the reading (or re-reading) of the document is terminated (YES in step S121), the process advances to step S122 described below. Otherwise, if it is determined that the reading (or re-reading) of the document is not terminated (NO in step S121), the process returns to step S101 described above (refer to FIG. 7).

Subsequently, in step S122, it is determined whether or not the current processing job starts to be output. If it is determined that the job starts to be output (YES in step S122), the process directly advances to step S124 described below. Otherwise, if it is determined that the job does not start to be output (NO in step S122), the job starts to be output (step S123), and the process advances to step S124 described below. Then, the MFP 1 waits until the output of the job is terminated (NO in step S124). As the output of the job is terminated (YES in step S124), the mode change processing is terminated (END).

As described above, the MFP 1 according to the present embodiment determines whether or not the re-reading is necessary in order to complete the job depending on the mode change instruction received after the start of the reading. If it is determined that the re-reading is necessary, the re-reading starts. Otherwise, if it is determined that the re-reading is not necessary, the reading is continuously performed.

Therefore, in the MFP 1 according to the present embodiment, it is possible to avoid the job from being interrupted when the re-reading is not necessary. Therefore, it is possible to effectively prevent the time necessary to complete the job from increasing by changing the operational mode after the start of the reading.

In the MFP 1 according to the present embodiment, if it is determined that the re-reading is necessary, the operation screen G30 for causing a user to select whether or not the mode change instruction is confirmed is displayed (refer to FIG. 10). If the mode change instruction is not confirmed on the operation screen G30, the mode change instruction is cancelled. Therefore, in the MFP 1 according to the present embodiment, if a user does not want to re-read the document, the reading (or output of the job) is continuously performed in the unchanged operational mode.

Furthermore, in the MFP 1 according to the present embodiment, if it is determined that the re-reading is necessary, a message M2 for urging a user to perform the re-reading preparation job is displayed (refer to FIG. 11). Therefore, in the MFP 1 according to the present embodiment, it is possible to improve user's convenience and rapidly start the re-reading.

The present invention is not limited to the aforementioned embodiment, but may be variously modified within the scope of claims. For example, although the copy job is exemplified as a job executed by the MFP 1 in the aforementioned embodiment, the invention may similarly apply to any job if it is involved in reading of a document. For example, the invention may similarly apply to a scan job or a facsimile job.

Although, in the aforementioned embodiment, it is determined that the re-reading of an document is necessary in a case where an output image quality of the job is changed by the mode change instruction, or a reading range or a reading speed of the document changes, determination criteria regarding whether or not the re-reading of a document is necessary are not limited thereto. For example, an individual determination criterion may be employed depending on each device or each user.

A means and a method for performing various processings in the image forming apparatus according to the present embodiment may be implemented using either a dedicated hardware circuit or a programmed computer. The aforementioned program may be provided, for example, using a computer readable recording medium such as a flexible disc and a compact disc read only memory (CD-ROM) or in an on-line manner via a network such as the Internet. In this case, a program recorded on a computer readable recording medium is typically transmitted to and stored in a storage device such as a hard disk. In addition, the aforementioned program may be provided as individual application software or may be embedded in software as a functionality of the image forming apparatus.

What is claimed is:

1. An image forming apparatus that executes a job involved in reading of a document, comprising:
a reading part that starts reading of the document depending on an operational mode specified in advance;
a receiving part that receives an operational mode change instruction after the reading of the document starts;
a determination part that determines whether or not re-reading of the document is necessary in order to complete the job depending on an operational mode changed by the change instruction; and
a control part that controls an operation of the reading part such that re-reading of the document starts if it is determined that re-reading of the document is necessary, or the document is continuously read if it is determined that the re-reading is not necessary.

2. The image forming apparatus as claimed in claim 1, wherein the control part controls an operation of the reading part such that the reading of the document is interrupted if the change instruction is received before the reading of the document is terminated.

3. The image forming apparatus as claimed in claim 2, wherein the control part controls an operation of the reading part such that the reading of the document is interrupted after a currently reading page at the time of receiving the change instruction is completely read.

4. The image forming apparatus as claimed in claim 1, wherein an output of the job is interrupted if the change instruction is received after the reading of the document is terminated.

5. The image forming apparatus as claimed in claim 1, wherein the determination part determines that re-reading of the document is necessary if the output image quality of the job is changed by the change instruction.

6. The image forming apparatus as claimed in claim 1, wherein the determination part determines that re-reading of the document is necessary if a reading range or a reading speed of the document is changed by the change instruction.

7. The image forming apparatus as claimed in claim 1, further comprising a display unit that displays a message for urging a user to perform a re-reading preparation job of the document if it is determined that re-reading of the document is necessary.

8. The image forming apparatus as claimed in claim 1, wherein the receiving part further receives a confirmation instruction regarding whether or not the change instruction is confirmed if it is determined that re-reading of the document is necessary, and
the change instruction is cancelled except for a case where the confirmation instruction for confirming the change instruction is received.

9. A non-transitory computer readable recording medium stored with a control program for controlling an image forming apparatus that executes a job involved in reading of a document, the control program causing a computer to execute a process comprising the steps of:
(A) starting reading of the document depending on an operational mode specified in advance;
(B) receiving an operational mode change instruction after the reading of the document starts;
(C) determining whether or not re-reading of the document is necessary in order to complete the job depending on an operational mode changed by the change instruction; and
(D) controlling the reading such that re-reading of the document starts if it is determined that re-reading of the document is necessary, or the document is continuously read if it is determined that the re-reading is not necessary.

10. The non-transitory computer readable recording medium as claimed in claim 9, wherein the control program causes a computer to execute a process further comprising the step of: (a) interrupting the reading of the document if the change instruction is received before the reading of the document is terminated.

11. The non-transitory computer readable recording medium as claimed in claim 10, wherein, in the step (a), the reading of the document is interrupted after a current reading page at the time of receiving the change instruction is completed.

12. The non-transitory computer readable recording medium as claimed in claim 9, wherein the control program causes a computer to execute a process further comprising the step of: (b) interrupting output of the job if the change instruction is received after the reading of the document is terminated.

13. The non-transitory computer readable recording medium as claimed in claim 9, wherein, in the (C) determination, it is determined that re-reading of the document is necessary if the output image quality of the job is changed by the change instruction.

14. The non-transitory computer readable recording medium as claimed in claim 9, wherein, in the (C) determination, it is determined that that re-reading of the document is necessary if a reading range or a reading speed of the document is changed by the change instruction.

15. The non-transitory computer readable recording medium as claimed in claim 9, wherein the control program causes a computer to execute a process further comprising the step of: (c) displaying a message for urging a user to perform a re-reading preparation job of the document if it is determined that re-reading of the document is necessary.

16. The non-transitory computer readable recording medium as claimed in claim 9, wherein the control program causes a computer to execute a process further comprising the step of (d) receiving a confirmation instruction regarding whether or not the change instruction is confirmed if it is determined that re-reading of the document is necessary, and
the change instruction is cancelled except for a case where the confirmation instruction for confirming the change instruction is received.

17. A method for controlling an image forming apparatus that executes a job involved in reading of a document comprising the steps of:
(A) starting reading of the document depending on an operational mode specified in advance;
(B) receiving an operational mode change instruction after the reading of the document starts;
(C) determining whether or not re-reading of the document is necessary in order to complete the job depending on an operational mode changed by the change instruction; and
(D) controlling the reading such that re-reading of the document starts if it is determined that re-reading of the document is necessary, or the document is continuously read if it is determined that the re-reading is not necessary.

18. The method as claimed in claim 17, further comprising the step of: (a) interrupting the reading of the document if the change instruction is received before the reading of the document is terminated.

19. The method as claimed in claim 18, wherein, in the step (a), the reading of the document is interrupted after a current reading page at the time of receiving the change instruction is completed.

20. The method as claimed in claim 17, further comprising the step of: (b) interrupting output of the job if the change instruction is received after the reading of the document is terminated.
